(19) United States
(12) Patent Application Publication
(10) Pub. No.: US 2010/0314891 A1
(43) Pub. Date: Dec. 16, 2010

(54) Grill for Assault Vehicle

(75) Inventor: David Acosta, Orem, UT (US)

Correspondence Address: HOLME ROBERTS & OWEN, LLP, 299 SOUTH MAIN, SUITE 1800, SALT LAKE CITY, UT, 84111, US

(73) Assignee: OC, LLC, Orem, UT (US)

(21) Appl. No.: 12/471,871

(22) Filed: May 26, 2009

(51) Int. Cl. B60R 19/54; B60R 19/52; B23P 11/00

(52) U.S. Cl. 293/115; 296/193.1; 29/428

(57) ABSTRACT

An assault grill for attachment to a vehicle is disclosed, the assault grill being configured for impacting doors in such a way that the door is deflected upwards. The grill includes a support member, one or more longitudinal support members, and two or more lateral members. In one embodiment, a first lateral member and a second lateral member are spaced different perpendicular distances from the longitudinal support member. In another embodiment, a line through a center of the first lateral member and a center of the second lateral member forms an angle with a line parallel to the longitudinal support member.

### FIELD

The present invention relates to a grill and ram attachable to a vehicle and specially configured to break through doors, including locked, chained, and barred doors, such as those in public, private, and commercial buildings in such a way that the door is deflected upward.

### BACKGROUND

Police tactical units have needed to breach doors and other entrances for some time. Recently, however, the need has become more acute as hostage situations and criminal acts referred to as “active shooter” scenarios in which a gunmen is actively shooting victims requires a quick response by the police in order to save as many hostages and/or victims as possible rather than using negotiations as a tactic as in more typical hostage situations.

Compounding the difficulty of responding to an active shooter or a hostage situation in an unknown environment, recent events have involved gunmen that lock or barricade one or more doors to the building in which they have taken hostages and/or are shooting victims. Such situations occurred in the school shootings that occurred in Breslan, Russia and at Virginia Tech University. For example, the shooter at Virginia Tech chained and pad-locked the double doors to the school building, delaying the tactical units responding to the situation.

Faced with chained and barricade doors, police tactical units have the time consuming and dangerous task of breaching the door in such a manner that they can quickly evacuate a large number of hostages, potentially wounded victims, and others safely from the premise. A large opening or breach needs to be made to enable a quick evacuation of large numbers of people safely. However, it typically takes a longer period of time to create a large breach or opening, delaying the time before police units can reach the victims and/or the shooter. In addition, the longer the police units are exposed at a doorway, particularly a clear, glass doorway that is typically used in public and commercial buildings increases the time the police are potentially exposed to hostile fire and other reactions from any shooter. In addition, the longer it takes to create a breach the more likely a shooter will discover the response of law enforcement, creating a window for the shooter to take active counter measures, including firing at the police, as mentioned, shooting hostages and/or other bystanders, igniting explosives, incendiary devices, and/or other similar devices. In the event, the tactical responders and the hostages and/or bystanders are put at increased risk of harm.

While hand-held door rams have been used in the past to breach a door, these are effective primarily for the doors used in apartments and family residences. In addition, the use of such rams does not create a large breach and may be ineffective in the event the door is chained or otherwise barricaded, as was the case at Virginia Tech. Further, the use of hand-held rams exposes the responding tactical units to counter-fire and other risks, especially when the doors are glass or otherwise clear, a factor compounded by the fact that the use of such rams can be time-consuming. Other drawbacks are that the door often remains on the hinges where it is capable of potentially closing and, in the worse case, locking or blocking the doorway behind the entering tactical units, creating a trap for the tactical units and barring yet again the escape route for any hostages and/or victims. Even if the door remains clear, debris from the door (if damaged), the frame, and elsewhere might create obstructions for the responding tactical units entering the doorway and the hostages and/or victims attempting to escape.

Because active shooters intent on killing and harming as many people as possible, particularly at schools, is a relatively new phenomenon, and because of recent shifts in law enforcement strategies that call for a rapid response in the situation of an active shooter, the delay in quickly creating a large breach has recently developed as a significant problem, one that the Applicant believes has not been recognized before. Further, these particular circumstances call for equipment that overcomes the significant shortfalls in the previous equipment and methods described above.

Thus, there exists a need for equipment that will quickly create large breach through doors, whether private, public, or commercial. The equipment should breach a door in such a way that any debris, particularly the door, should deflect clear of the breached doorway lest the debris and/or the door itself become a further barrier to police tactical units entering the building and hostages and/or victims escaping from the building.

### SUMMARY

It is to be understood that the present invention includes a variety of different versions or embodiments, and this Summary is not meant to be limiting or all-inclusive. This Summary provides some general descriptions of some of the embodiments, but may also include some more specific descriptions of other embodiments.

Embodiments of the one or more present inventions include an assault grill for attachment to a vehicle, typically, although not necessarily, an armored assault vehicle, such as an armored van equipped to carry members of a tactical unit. The assault grill includes a support member, such as a bumper, typically made of steel plate with mounting members for attaching the support member to a frame of the vehicle. One or more longitudinal support members, typically vertical supports, have a first end and a second end spaced apart from the first end, with one of the ends affixed to the support member. Embodiments of the invention include two or more lateral members affixed thereto. The first lateral member is affixed in a first position on the longitudinal support member between the first end and the second end. The second lateral member is affixed to the longitudinal support member between the first lateral member and either the first end or the second end.

In one embodiment, the first lateral member is affixed a first perpendicular distance away from the longitudinal support member while the second lateral member is affixed a second perpendicular distance away from the longitudinal support member.

In another embodiment, the first lateral member and the second lateral member are affixed to the longitudinal support member such that a first line extending through a center of the first lateral member and a center of the second lateral member forms an angle with a parallel line extending from the longitudinal support member.

Another embodiment of the assault grill includes a grill attached to a vehicle having a frame and at least two wheels.

Also described herein are methods of making an assault grill of the type disclosed.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 is a side perspective view of an embodiment of an assault grill;

FIG. 2 is a top view of the embodiment of the assault grill in FIG. 1;

FIG. 3 is a front view of the assault grill shown in FIG. 1;

FIG. 4 is a side view of the assault grill shown in FIG. 1;

FIG. 5 is a cross-sectional view of the assault grill shown in FIG. 3;

FIG. 6 is a side perspective view of another embodiment of an assault grill;

FIG. 7 is top view of the assault grill in FIG. 6 with an optional ram;

FIG. 8 is a top view of the assault grill in FIG. 6 without the optional ram;

FIG. 9 is a side view of the assault grill in FIG. 6;

FIG. 10 is a side view of the assault grill in FIG. 8;

FIG. 11 is a front view of the assault grill in FIG. 6;

FIG. 12 is a front view of the assault grill in FIG. 8; and,

FIG. 13 is cross-section view of the assault grill in FIG. 12.

FIG. 14 is a view of an embodiment of an assault grill attached to a vehicle and impacting a door.

The drawings are not necessarily to scale.

### DETAILED DESCRIPTION

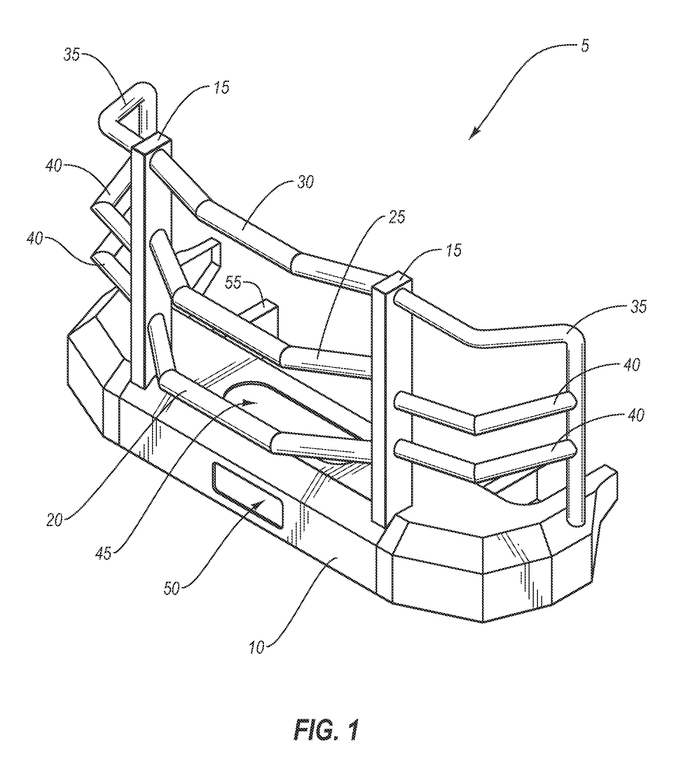

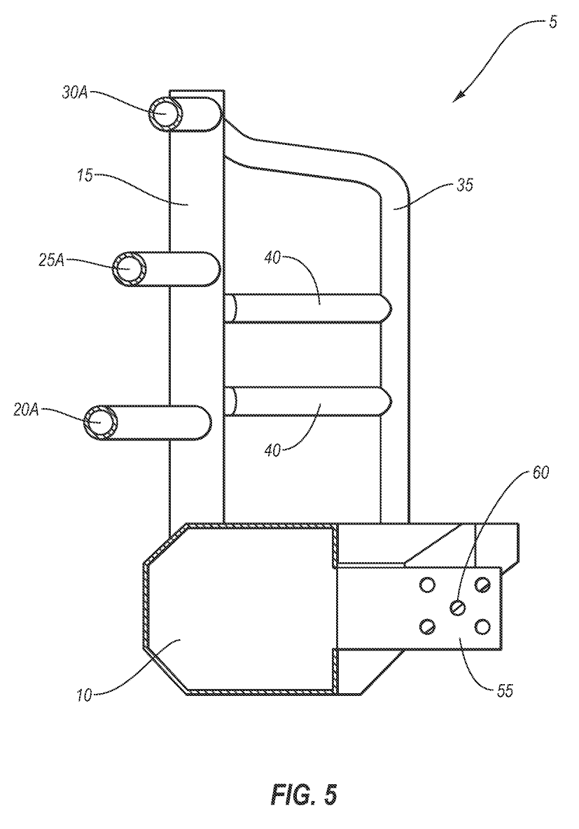

At least one embodiment of the one or more present inventions is illustrated in FIGS. 1-5. An assault grill 5 includes a support member 10. In this embodiment the support member 10 is a bumper manufactured from heavy plate steel, such as ⅛ inch steel. The support member can be formed as a single piece, such as by molding, stamping, hydroforming, and other methods known in the art. Alternatively, the support member 10 can be formed from one or more pieces of plate steel or other material welded, bolted, or otherwise joined together as known in the art. The support member 10 can of course be manufactured from other metals and materials, including composites. The support member 10, while illustrated as a bumper, can be at the top of the assault grill 5 rather than the bottom, in the middle, or in another location. While the support member 10 is illustrated as being horizontal or substantially horizontal, it is contemplated that the support member 10 can be formed of two or more pieces joined at an angle.

The support member 10 can be joined directly to a vehicle as will be described below, such as by welding, but more typically the support member 10 includes one or more mounting members 55 configured to attach the support member 10 to a frame of the vehicle, typically through the use of mounting bolts 60, although other mechanisms of attaching the mounting member 55 to the frame of the vehicle, including pins and other types of mounting mechanisms known in the art. In this embodiment, the mounting member 55 is a steel beam, such as an I-beam, and can be formed as a single piece, such as by molding, stamping, hydroforming, and other methods known in the art. Alternatively, the mounting member 55 can be formed from one or more pieces of steel or other material welded, bolted, or otherwise joined together as known in the art. The mounting member 55 can of course be manufactured from other metals and materials, including composites.

The support member 10 optionally includes locations configured to receive a winch at the winch location 45. In addition, when the support member 10 is configured to receive a winch it optionally includes a winch cable opening 50 in the support member 10 configured to allow a winch cable to be paid out and reeled in.

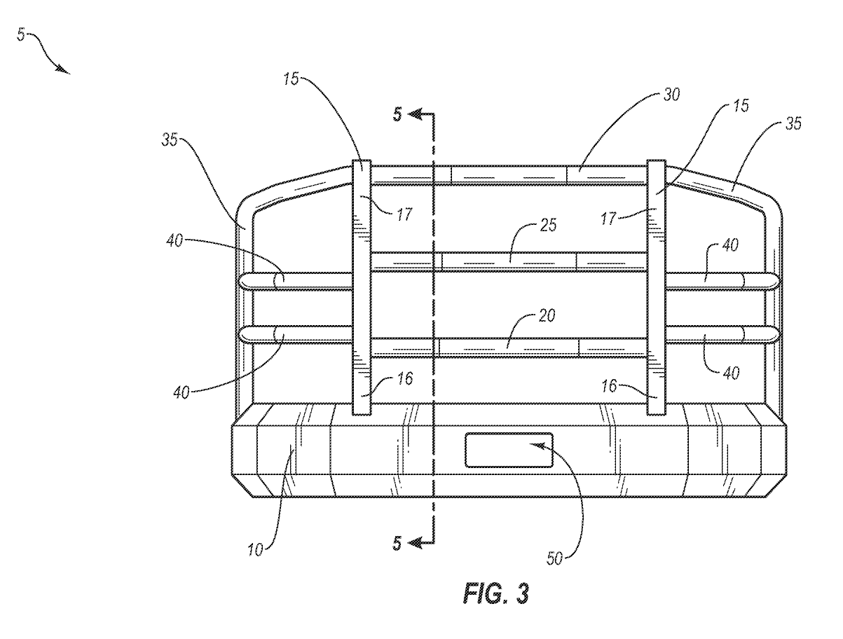

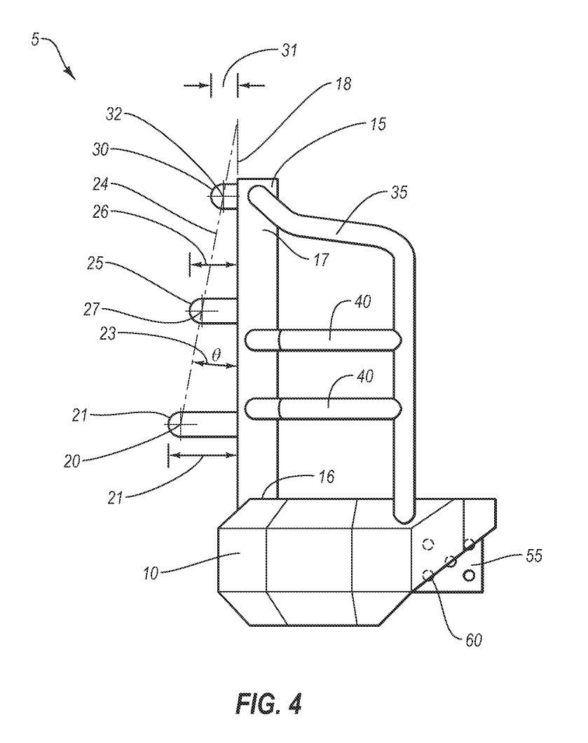

The assault grill 5 includes one or more longitudinal members 15, the longitudinal members 15 having a first end 16 and a second end 17 best illustrated in FIGS. 3 and 4. The first end 16 of each longitudinal member 15 is illustrated affixed to the support member 10, although other embodiments may have the second end 17 affixed to the support member 10. The longitudinal members 15 typically are welded to the support member 10, but they can be affixed to the longitudinal members 15 in other ways known in the art, included being formed of a single piece, bolted, pinned and other known methods. In this embodiment, the longitudinal members 15 are substantially vertical and perpendicular to the support member 10, but other embodiments of the longitudinal members 15 include ones that are at an angle directed upward (or downward, in the event that the support member 10 is affixed at the second end 17), slanted, or otherwise oriented as one having ordinary skill in the art would understand. In this embodiment, the longitudinal members 15 are steel rods, pipes, bar stock, or bar stock, and can be formed as a single piece, such as by molding, stamping, hydroforming, extruded, rolled, and other methods known in the art. Alternatively, the longitudinal members 15 can be formed from one or more pieces of steel or other material welded, bolted, or otherwise joined together as known in the art. The longitudinal members 15 can of course be manufactured from other metals and materials, including composites.

The assault grill 5 includes two or more lateral members. In the embodiment illustrated, these include a first lateral member 20, a second lateral member 25, and, optionally, a third lateral member 30. The configuration of the lateral members 20, 25, and 30 is selected to deflect a door upward as will be described in further detail below. In this embodiment, the lateral members 20, 25, and 30 are a steel rods, pipes, or bar stock, and can be formed as a single piece, such as by molding, stamping, hydroforming, extruded, rolled, and other methods known in the art. Alternatively, the lateral members 20, 25, 30 can be formed from one or more pieces of steel or other material welded, bolted, or otherwise joined together as known in the art. The lateral members 20, 25, 30 can of course be manufactured from other metals and materials, including composites. The lateral members 20, 25, 30 are typically welded to the one or more longitudinal members 15, but they can be affixed to the longitudinal members 15 in other ways known in the art, included being formed of a single piece, bolted, pinned and other known methods.

The lateral members 20, 25, 30 as illustrated are substantially parallel to the long axis of the support member 10 and perpendicular to the longitudinal members 15, but other embodiments of the lateral members 20, 25, 30 includes ones that are at one or more (if the lateral members are formed from multiple pieces) angles relative to the longitudinal members 15, slanted either upwards or downwards, or otherwise oriented as one having skill in the art would understand.

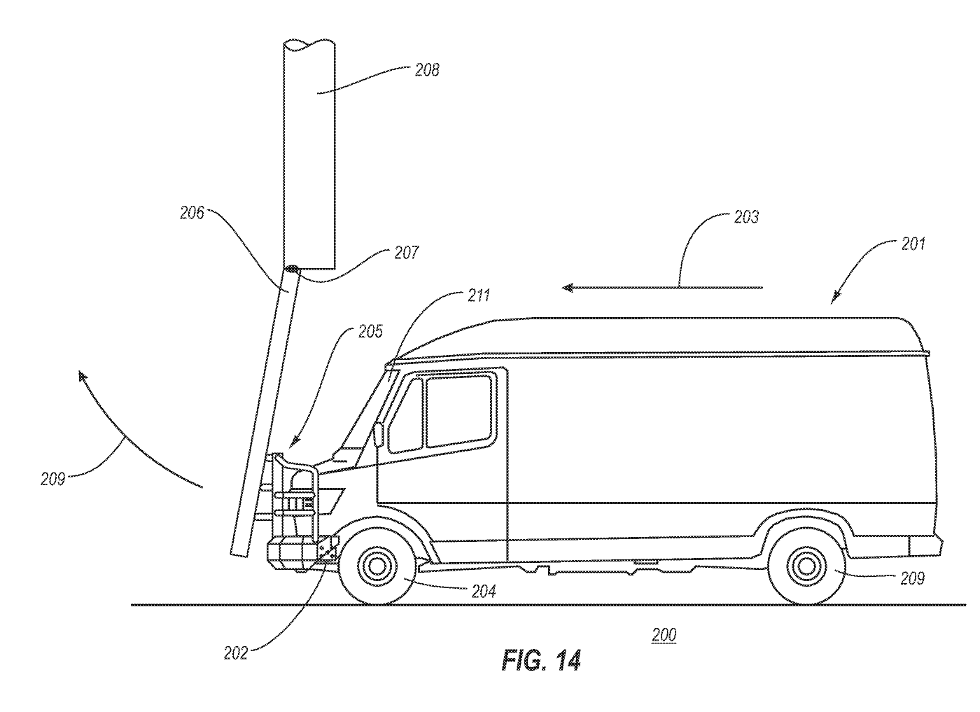

Typically, the height of the first lateral member 20 above the ground when mounted to a vehicle is selected to be proximate a standard height of a door handle, push bar, or knob. This height typically falls within a range of 32 inches to 44 inches and, more typically, a range of between 36 inches and 40 inches. The second lateral member 25 is typically spaced 10 to 25 inches apart from the first lateral member 20 in a vertical direction (i.e., in a direction perpendicular to the ground). The third lateral member 30, if included, is spaced 10 to 25 inches apart from the second lateral member 25 in a vertical direction (i.e., in a direction perpendicular to the ground). The uppermost lateral member (the third lateral member 30 in this instance) is high enough to ensure that a door that is impacted by the assault grill 5 (discussed in greater detail below viz-a-viz FIG. 14) will be raised above a hood of the vehicle and the windshield and, preferentially, over the vehicle, while at the same time not being so high as to block or obscure the view of the driver through the windshield. Alternatively, the lateral members 20, 25, and 30 can be attached to the longitudinal members 15 in such a way that allows the absolute height above the ground of the longitudinal members 20, 25, and 30 as well as the relative height between each of the lateral members 20, 25, and 30 to be adjusted. For example, the lateral members 20, 25, and 30 and the longitudinal members 15 can incorporate a series of pins and holes that allow for an adjustable height, sliding-locking mechanisms, gears with locking pawls, and other means of adjusting the height known in the art.

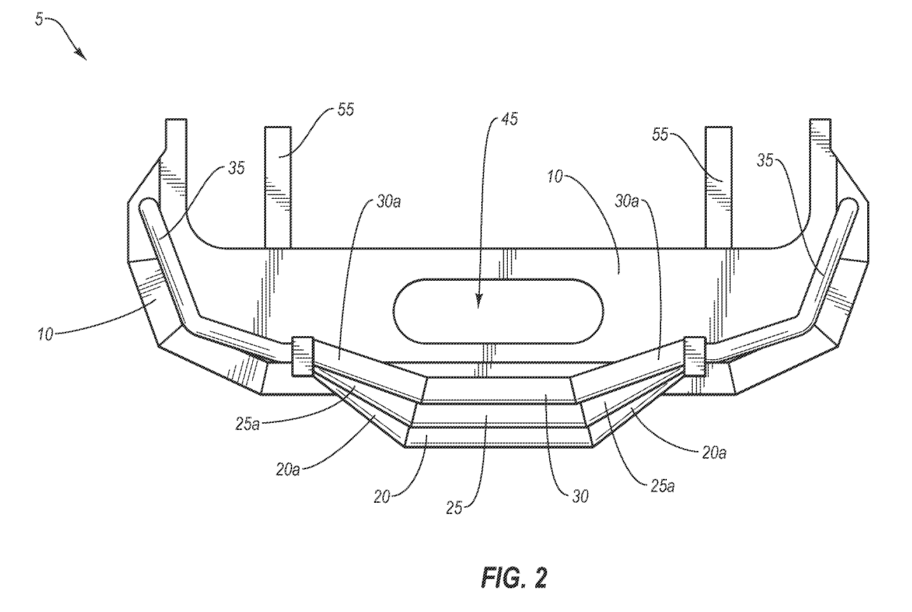

Best illustrated in FIGS. 2 and 4 are the lateral members 20, 25, and 30. First lateral member 20 optionally includes segments 20a; second lateral member 25 optionally includes segments 25a; and, third lateral member 30 optionally includes segments 30a. Each segment 20a, 25a, and 30a is formed integrally with its associated lateral member, such as by hydroforming, extruding, pressing, or other method known in the art. Alternatively, the segments 20a, 25a, and 30a can be affixed to its respective lateral members 20, 25, and 30 by welding, bolting, pinned, or other methods of affixing that are known in the art. The segments 20a, 25a, and 30a are steel rods, pipes, bar stock, or bar stock, and can be formed as a single piece, such as by molding, stamping, hydroforming, extruded, rolled, and other methods known in the art. Alternatively, the segments 20a, 25a, and 30a can be formed from one or more pieces of steel or other material welded, bolted, or otherwise joined together as known in the art. The segments 20a, 25a, and 30a can of course be manufactured from other metals and materials, including composites.

In the embodiment illustrated in FIG. 4, the segments 20a, 25a, and 30a are configured to extend the lateral members 20, 25, and 30 a selected distance from a line 18 parallel to the longitudinal support members 15. For example, the segment 20a positions the lateral member 20 a selected first distance 21 away from the line parallel 18; the segment 25a positions the lateral member 25 a selected second distance 26 from the parallel line 18; and the segment 30a positions the lateral member 30 a selected third distance 31 from the parallel line 18. In the embodiment illustrated, the length of the first distance 21 is greater than the length of the second distance 26, which itself is greater than the third distance 31. Of course, it will be understood that a different selected length or relative configuration for the first distance 21, second distance 26, and third distance 31 fall within the scope of the disclosure. Stated differently, while FIG. 4 illustrates a proportionate relationship between the length of the first distance 21 and the second distance 26 that is substantially the same as the proportionate relationship between the length of the second distance 26 and the third distance 31, other relationships or relative proportions between the different distances fall within the scope of the disclosure, i.e., the proportionate relationship between the different distances need not be substantially the same.

In another embodiment, each of lateral members 20, 25, and 30 include a first center 22, a second center 27, and a third center 32, respectively. A line 24 passing through each of the first, second, and third centers 22, 27, and 32 intersects with a parallel line 18 that is parallel with the longitudinal support member 15 to form an angle 23 of a selected range θ. In various embodiments, the selected angle is between the range θ of 0 to 45° and, more preferentially, 0 to 30°, and, even more preferentially, 0 to 15°. Other embodiments include those in which a first angle formed by a line through the first center 22 and the second center 27 and the parallel line 18 varies from a second angle formed by a line through the second center 27 and the third center 32 and the parallel line 18. The first angle can be substantially the same, greater than, or less than the second angle, as one having skill in the art would understand.

A purpose for selecting and positioning the lateral members 20, 25, and 30 in such a way is for use in impacting a door or doors of a building and quickly creating a large breach through which both police units and first responders/emergency personnel can enter and through which hostages and/or victims can escape. It is believed that a need for this ability was not previously recognized, in part because the likelihood and deadliness of an active shooter, particularly one who has barricaded, chained, or otherwise blocked the door, was not previously appreciated and/or expected. Such events required a shift in the paradigmatic response from police units, thus creating a previously unrecognized need.

Turning to FIG. 14, when in use the assault grill 205 is attached to a vehicle 201 with at least two wheels 204 traveling along the ground 200, typically an armored vehicle to provide protection to the driver and others inside the vehicle, at the vehicle's frame 202, as discussed above. The vehicle 201 is driven in a direction 203 towards a barricaded or locked door 206 of a building 208, aiming to have the first lateral member 20 (illustrated best in FIG. 1) strike at approximately the height of the door handle or knob of the door 206. (Of course, tactical considerations may not make a precise, center-aligned impact possible, but the disclosed embodiments still perform desirably in these situations.) Many doors 206 in modern, commercial, and public buildings are designed to pivot upwards at the top of the door (pivot 207) with the bottom of the door swinging upwards in direction 209, when desired, in addition to pivoting about its hinges. Typically, this is selectively done for maintenance or to allow oversize items that would not otherwise fit through the door to be brought into the building conveniently and easily. The embodiments of the invention disclosed herein take advantage of this feature of the doors (a feature conceived for a very different purpose) in the following way. The impact of the assault grill 205 and, particularly, the first lateral member 20, applies a force across a large, lateral portion of the door 206. This force drives the door 206 inward and upward, aided, in part, by the forward movement of the vehicle itself in direction 203. The lower, first lateral member 20 drives the lower portion of the door 206 inward, with the second lateral member 25 configured at a second distance 26 catching and supporting the door 206 as it swings upward in direction 209. The optional third lateral member 30 further supports the door 206 and provides a force higher along the door 206 to clear the door over a windshield 211 of the vehicle 201. This raises and clears the door 206 from the doorway and the breach, allowing the vehicle 201 to pass partially or entirely through the breach, and ensures that the door 206 and related debris, if any, is raised up and over the vehicle 201 for the most part rather than falling back into the breach where it might hinder police units, emergency responders, hostages, and/or victims.

While the embodiments of the invention are configured to work well with doors of the type described above, they work equally well with doors of other types, including steel industrial doors that only pivot along the hinges rather than upward, and other doors. As the hinges of any door are often the weakest point in the door, a vehicle configured with an embodiment of the assault grill disclosed that has sufficient velocity and momentum would typically cause even doors of other types to be raised upward and clear of the vehicle and the breach.

Turning back to FIGS. 1-5, the assault grill 5 optionally includes one or more secondary support members 35, as well as one or more lateral support members 40. These support members provide additional structural support to the longitudinal support member(s) 15 and the lateral members 20, 25, and 30 that bear a large portion of any impact forces generated when the assault grill 5 impacts a door, wall or other fixed barricade. In addition, the secondary support members 35 and lateral support members 40 provide additional protection to the vehicle to which it is attached, particularly the front, the lights, and the quarter panels of the vehicle when the assault grill 5 is used to impact doors.

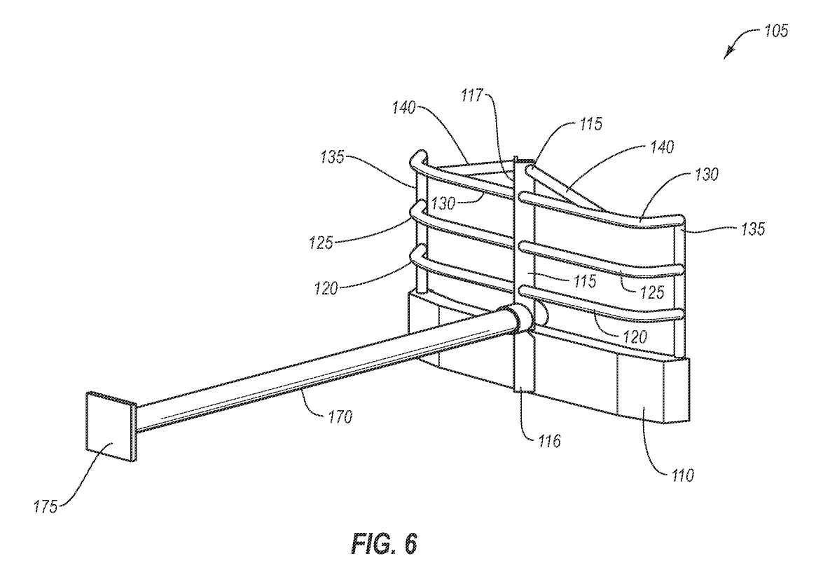

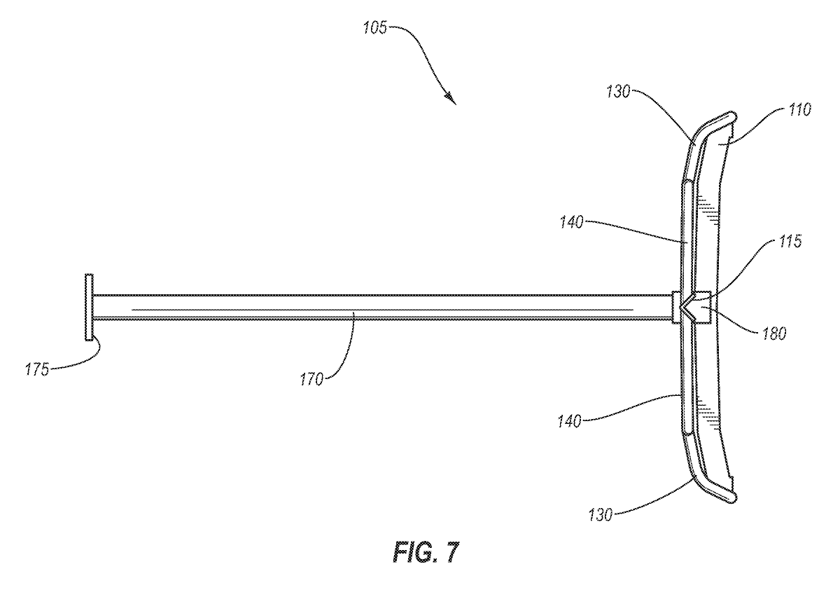

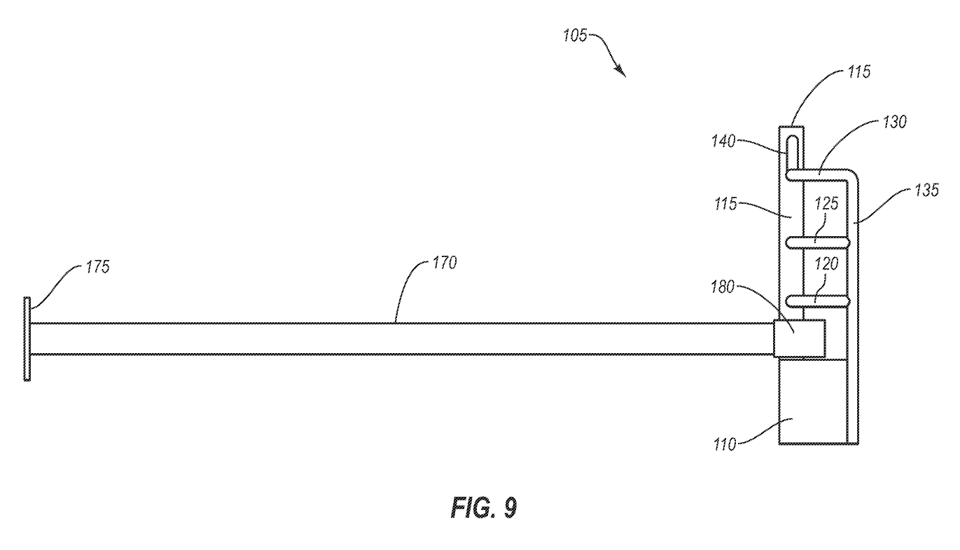

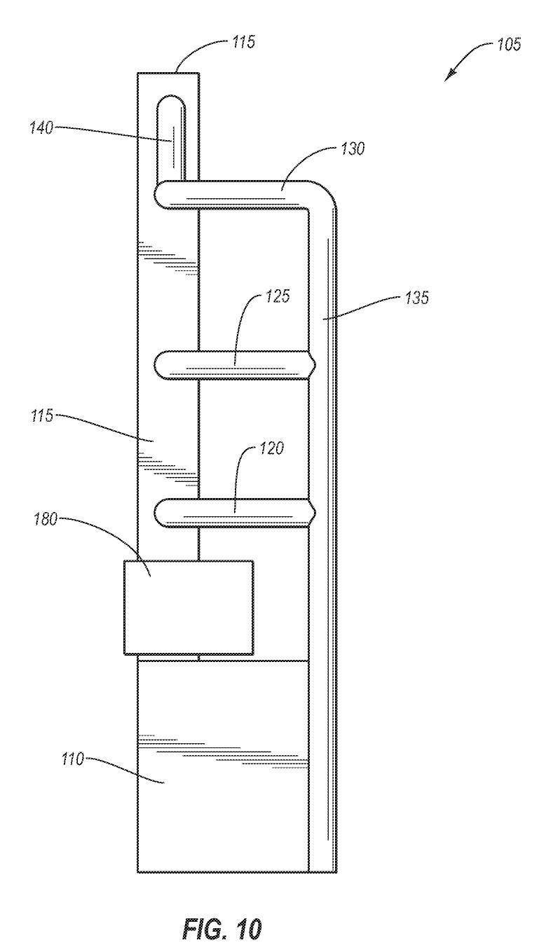

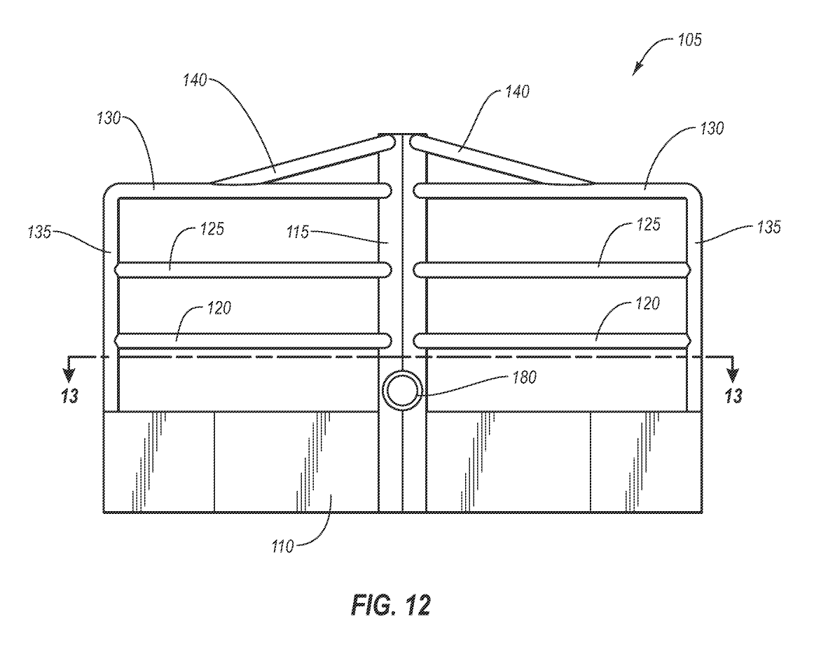

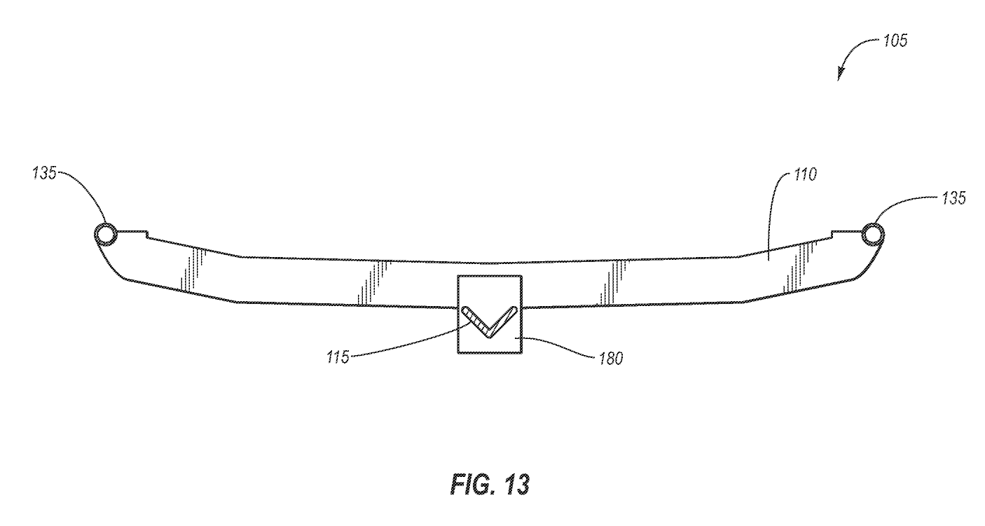

Illustrated in FIGS. 6-13 is another embodiment of the invention. An assault grill 105 includes a support member 110, similar in type to the support member 10 described above. The support member 110 can be joined directly to a vehicle as will be described below, such as by welding, but more typically the support member 110 includes one or more mounting members (not pictured) configured to attach the support member 110 to a frame of the vehicle, as described above.

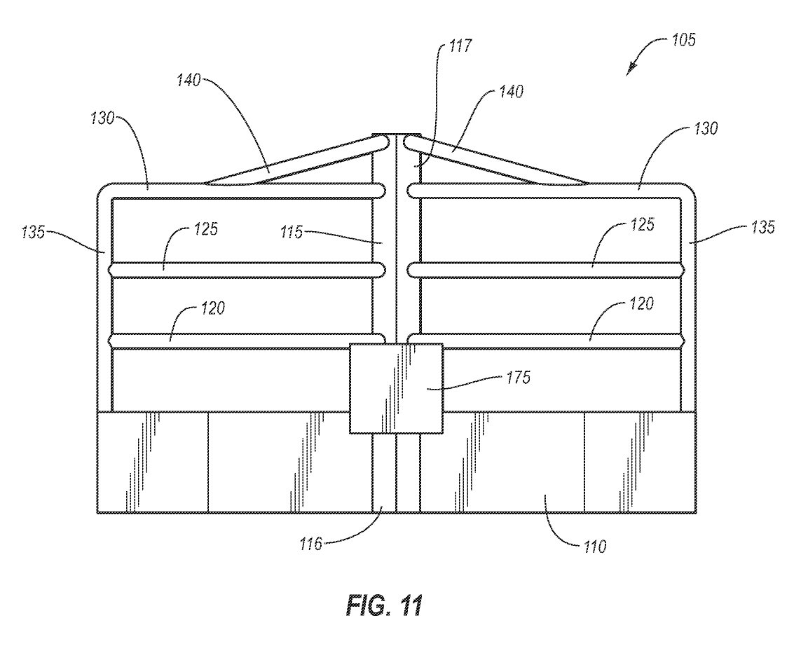

The assault grill 105 includes one or more longitudinal members 115, the longitudinal member 115 having a first end 116 and a second end 117 best illustrated in FIGS. 6 and 11. The first end 116 of the longitudinal member 115 is illustrated affixed to the support member 110, although other embodiments may have the second end 117 affixed to the support member 110. The longitudinal member 115 typically is welded to the support member 110, but they can be affixed to the longitudinal members 115 in other ways known in the art, included being formed of a single piece, bolted, pinned and other known methods. In this embodiment, the longitudinal members 115 is substantially vertical and perpendicular to the support member 110, but other embodiments of the longitudinal members 115 include ones that are at an angle directed upward (or downward, in the event that the support member 110 is affixed at the second end 117), slanted, or otherwise oriented as one having ordinary skill in the art would understand. In this embodiment, the longitudinal member 115 is manufactured from angle iron/stock, but other materials such as steel rods, pipes, bar stock, or bar stock, can be used to form the longitudinal member 115 as a single piece, such as by molding, stamping, hydroforming, extruded, rolled, and other methods known in the art. Alternatively, the longitudinal member 115 can be formed from one or more pieces of steel or other material welded, bolted, or otherwise joined together as known in the art. The longitudinal member 115 can of course be manufactured from other metals and materials, including composites.

The assault grill 105 includes two or more lateral members. In the embodiment illustrated, these include a first lateral member 120, a second lateral member 125, and, optionally, a third lateral member 130. The configuration of the lateral members 120, 125, and 130 is selected to deflect a door upward as will be described in further detail below. In this embodiment, the lateral members 120, 125, and 130 are a steel rods, pipes, or bar stock, and can be formed as a single piece, such as by molding, stamping, hydroforming, extruded, rolled, and other methods known in the art. Alternatively, the lateral members 120, 125, and 130 can be formed from one or more pieces of steel or other material welded, bolted, or otherwise joined together as known in the art. The lateral members 120, 125, and 130 can of course be manufactured from other metals and materials, including composites. The lateral members 120, 125, and 130 are typically welded to the one or more longitudinal member 115, but they can be affixed to the longitudinal member 115 in other ways known in the art, included being formed of a single piece, bolted, pinned and other known methods.

The lateral members 120, 125, and 130 as illustrated are substantially parallel to the long axis of the support member 110 and perpendicular to the longitudinal member 115, but other embodiments of the lateral members 120, 125, and 130 includes ones that are at one or more (if the lateral members are formed from multiple pieces) angles relative to the longitudinal member 115, slanted either upwards or downwards, or otherwise oriented as one having skill in the art would understand.

Typically, the height of the first lateral member 120 above the ground when mounted to a vehicle is selected to be proximate a standard height of a door handle, push bar, or knob. This height typically falls within a range of 32 inches to 44 inches and, more typically, a range of between 36 inches and 40 inches. The second lateral member 125 is typically spaced 10 to 25 inches apart from the first lateral member 120 in a vertical direction (i.e., in a direction perpendicular to the ground). The third lateral member 130, if included, is spaced 10 to 25 inches apart from the second lateral member 125 in a vertical direction (i.e., in a direction perpendicular to the ground). The uppermost lateral member (the third lateral member 130 in this instance) is high enough to ensure that a door that is impacted by the assault grill 105 (discussed in greater detail above viz-a-viz FIG. 14) will be raised above a hood of the vehicle and the windshield and, preferentially, over the vehicle, while at the same time not being so high as to block or obscure the view of the driver through the windshield. Alternatively, the lateral members 120, 125, and 130 can be attached to the longitudinal member 115 in such a way that allows the absolute height above the ground of the longitudinal members 120, 125, and 130 as well as the relative height between each of the lateral members 120, 125, and 130 to be adjusted. For example, the lateral members 120, 125, and 130 and the longitudinal member 115 can incorporate a series of pins and holes that allow for an adjustable height, sliding-locking mechanisms, gears with locking pawls, and other means of adjusting the height known in the art.

As described above, a line passing through each of the first, second, and third centers of the lateral members 120, 125, and 130 intersects with a parallel line that is parallel with the longitudinal support member 115 to form an angle of a selected range θ. (This is best illustrated and discussed above viz-a-viz FIG. 4.) In various embodiments, the selected angle is between the range of 0 to 45° and, more preferentially, 0 to 30°, and, even more preferentially, 0 to 15°. Other embodiments include those in which a first angle formed by a line through the first center and the second center and the parallel line varies from a second angle formed by a line through the second center and the third center and the parallel line. The first angle can be substantially the same, greater than, or less than the second angle, as one having skill in the art would understand.

The assault grill 105 optionally includes one or more secondary support members 135, as well as one or more lateral support members 140. These support members provide additional structural support to the longitudinal support member 115 and the lateral members 120, 125, and 130 that bear a large portion of any impact forces generated when the assault grill 105 impacts a door, wall or other fixed barricade. In addition, the secondary support members 135 and lateral support members 140 provide additional protection to the vehicle to which it is attached, particularly the front, the lights, and the quarter panels of the vehicle when the assault grill 105 is used to impact doors.

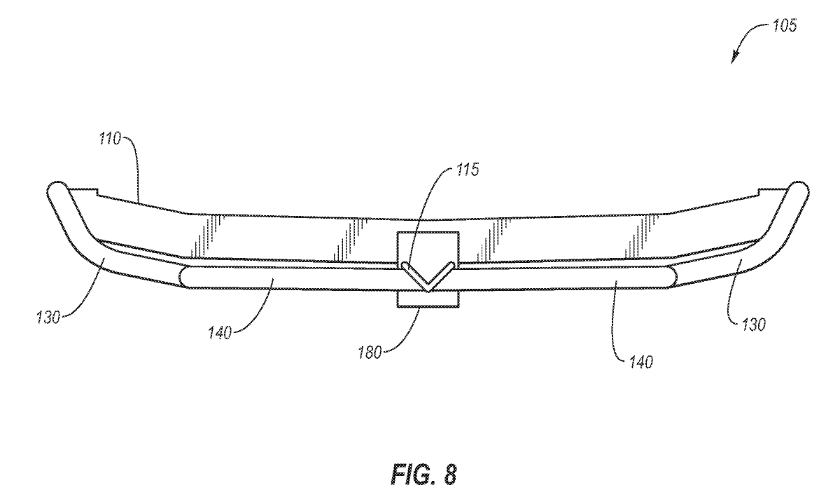

Optionally, the assault grill 105 includes a ram 170 with a ram plate 175 attached via ram mounting bracket 180, best illustrated in FIGS. 8-10. The ram 170 and ram plate 175 are typically welded together, although the ram plate 175 can be removable for replacement and repair via bolts, screws, pins, or other methods of attaching the ram plate 175 to the ram 170 as known in the art. The ram 170, ram plate 175, and ram mounting bracket 180 can be made from steel rods, pipes, or bar stock, and can be formed as a single piece, such as by molding, stamping, hydroforming, extruded, rolled, and other methods known in the art. Alternatively, the ram 170, ram plate 175, and ram mounting bracket 180 can be formed from one or more pieces of steel or other material welded, bolted, or otherwise joined together as known in the art. The ram 170, ram plate 175, and ram mounting bracket 180 can of course be manufactured from other metals and materials, including composites. The ram mounting bracket can be configured to be moved in height and location and attach to one or more of the longitudinal support member 115 and lateral members 120, 125, and 130 through the use of various bolts, screws, pins, sliding locking mechanisms, gears and pawls, and other means for adjustable mounting known in the art.

The ram 170 and ram plate 175 is configured to impact doors, typically soft- or hard-wood doors used in private or residential construction, usually a single door. (Double doors typically would not be impacted with the ram 170, but rather the assault grill 5 and/or 105 itself as described above.)

Methods of making an assault grill of the type disclosed herein also fall within the scope of the invention and is best illustrated with reference to FIGS. 1-5 and 14. The method includes providing a support member 10 with a mounting member 55, the mounting member 55 configured for attaching the support member 10 to a vehicle, such as vehicle 201 illustrated in FIG. 14, typically via the frame 202 of the vehicle 201. At least one longitudinal support 15 member is provided, the longitudinal support member 15 having a first end 16 and a second end 17 spaced apart from the first end 16. One of the first end 16 and second end 17 is affixed to the support member 10. A first lateral member 20 is provided and affixed to the longitudinal support member 15 at a first location between the first end 16 and the second end 17 and positioned a first perpendicular distance 21 from the longitudinal support member 15. A second lateral member 25 is also provided and affixed to the longitudinal support member 15 at a second location between the first location and one of the first end 16 and the second end 17. The second lateral member 25 is positioned a second perpendicular distance 26 from the longitudinal support member 15.

The one or more present inventions, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An assault grill configured for attachment to a vehicle, said assault grill comprising:
a support member, said support member including a mounting member affixed thereto, said mounting member configured for attaching said support member to said vehicle;
at least one longitudinal support member having a first end and a second end spaced apart from said first end, one of said first end and said second end being affixed to said support member;
a first lateral member affixed to said longitudinal support member at a first location between said first end and said second end of said longitudinal support member and positioned a first perpendicular distance from said support member; and,
a second lateral member affixed to said longitudinal support member at a second location between said first location and one of said first end and said second end of said longitudinal support member and positioned a second perpendicular distance from said support member that is different from said first perpendicular distance.

2. The assault grill of claim 1, wherein said first perpendicular distance is greater than said second perpendicular distance.

3. The assault grill of claim 2, wherein said first perpendicular distance is less than said second perpendicular distance.

4. The assault grill of claim 2, wherein said first perpendicular distance is equal to said second perpendicular distance.

5. The assault grill of claim 2, further comprising a third lateral member affixed to said longitudinal support member at a third location between said second location and one of said first end and said second end of said longitudinal support member and positioned a third perpendicular distance from said support member.

6. The assault grill of claim 5, wherein said second perpendicular distance and said third perpendicular distance are equal.

7. The assault grill of claim 5, wherein said second perpendicular distance is greater than said third perpendicular distance.

8. The assault grill of claim 5, wherein said second perpendicular distance is less than said third perpendicular distance.

9. The assault grill of claim 1, further comprising a second longitudinal support member having a first end and a second end spaced apart from said first end, said first end being affixed to said support member, said second longitudinal support member being spaced laterally apart from said first longitudinal support member.

10. The assault grill of claim 9, wherein said first lateral member and said second lateral member are each affixed to said second longitudinal support.

11. The assault grill of claim 1, further comprising a ram mounting bracket configured to accept a ram.

12. An assault vehicle, said assault vehicle comprising:
a frame having a front end and a back end, said frame including at least two wheels attached thereto;
a support member, said support member including a mounting member affixed thereto, said mounting member configured for attaching said support member to said front end of said frame, said support member including:
at least one longitudinal support member having a first end and a second end spaced apart from said first end, one of said first end and said second end being affixed to said support member;
a first lateral member affixed to said longitudinal support member at a first location between said first end and said second end of said longitudinal support member and positioned a first perpendicular distance from said support member; and,
a second lateral member affixed to said longitudinal support member at a second location between said first location and one of said first end and said second end of said longitudinal support member and positioned a second perpendicular distance from said support member that is different from said first perpendicular distance.

13. The assault grill of claim 12, wherein said first perpendicular distance is greater than said second perpendicular distance.

14. The assault grill of claim 12, wherein said first perpendicular distance is less than said second perpendicular distance.

15. The assault grill of claim 12, wherein said first perpendicular distance is equal to said second perpendicular distance.

16. The assault grill of claim 12, further comprising a third lateral member affixed to said longitudinal support member at a third location between said second location and one of said first end and said second end of said longitudinal support member and positioned a third perpendicular distance from said support member.

17. A method of making an assault grill configured for attachment to a vehicle, said method comprising:
providing a support member, said support member including a mounting member affixed thereto, said mounting member configured for attaching said support member to said vehicle;
providing at least one longitudinal support member having a first end and a second end spaced apart from said first end;
affixing one of said first end and said second end of said longitudinal support member to said support member;
providing a first lateral member;
affixing said first lateral member to said longitudinal support member at a first location between said first end and said second end of said longitudinal support member and positioned a first perpendicular distance from said support member;
providing a second lateral member;
affixing said second lateral member to said longitudinal support member at a second location between said first location and one of said first end and said second end of said longitudinal support member and positioned a second perpendicular distance from said support member.

18. An assault grill configured for attachment to a vehicle, said assault grill comprising:
a support member, said support member including a mounting member affixed thereto, said mounting member configured for attaching said support member to said vehicle;
at least one longitudinal support member having a first end and a second end spaced apart from said first end, one of said first end and said second end being affixed to said support member;
a first lateral member affixed to said longitudinal support member at a first location between said first end and said second end; and,
a second lateral member affixed to said longitudinal support member at a second location between said first location and one of said first end and said second end of said longitudinal support member and positioned such that a first line extending through a center of said first lateral member and a center of said second lateral member forms a first angle with a parallel line extending from said longitudinal support member.

19. The assault grill of claim 18, wherein said first angle is selected to cause a door to deflect upward when impacted by said assault grill.

20. The assault grill of claim 18, wherein said angle is between from about 0 degrees to about 45 degrees.

21. The assault grill of claim 18, wherein said angle is between from about 0 degrees to about 30 degrees.

22. The assault grill of claim 18, wherein said angle is between from about 0 degrees to about 15 degrees.

23. The assault grill of claim 18, further comprising a third lateral member affixed to said longitudinal support member at a third location between said second location and one of said first end and said second end of said longitudinal support member and positioned such that a second line extending through said center of said second lateral member and a center of said third lateral member forms a second angle with said parallel line extending from said longitudinal support member.

24. The assault grill of claim 23, wherein said first angle and said second angle are substantially the same.

25. The assault grill of claim 23, wherein said second angle is greater than said first angle.

26. The assault grill of claim 23, wherein said second angle is less than said first angle.

27. The assault grill of claim 18, further comprising a second longitudinal support member having a first end and a second end spaced apart from said first end, said first end being affixed to said support member, said second longitudinal support member being spaced laterally apart from said first longitudinal support member.

28. The assault grill of claim 28, wherein said first lateral member and said second lateral member are each affixed to said second longitudinal support.

29. The assault grill of claim 18, further comprising a ram mounting bracket configured to accept a ram.
